(19) United States
(12) Patent Application Publication
(10) Pub. No.: US 2026/0195633 A1
(43) Pub. Date: Jul. 9, 2026

(54) MACHINE LEARNING BASED STORAGE TIERING

(71) Applicant: International Business Machines Corporation, Armonk, NY (US)

(72) Inventor: Hai Jun Shen, Tianjin City (CN)

(21) Appl. No.: 19/008,808

(22) Filed: Jan. 3, 2025

(51) Int. Cl. G06N 20/00; G06F 16/2455

(52) U.S. Cl. CPC G06N 20/00; G06F 16/2455

(57) ABSTRACT

Mechanisms are provided for dynamically placing data for in-memory distributed query processing based on machine learning computer models. The mechanisms obtain machine learning training data comprising first features extracted from logs and metadata associated with data accesses in response to in-memory distributed query processing. The mechanisms execute machine learning training of a machine learning computer model based on the machine learning training data, to thereby train the machine learning computer model to predict data accesses based on the first features. The mechanisms execute the trained machine learning computer model on second features extracted from runtime data to generate a prediction of one or more datasets that will be accessed. The mechanisms execute a movement of the one or more datasets from high latency storage devices to memory based on the prediction.

### BACKGROUND

The present application relates generally to a data processing apparatus and method and more specifically to a computing tool and computing tool functionality for performing automatic storage tiering for in-memory distributed query engines based on machine learning.

Distributed Structured Query Language (SQL) technology distributes data in a cluster by deploying a logical relational database system across multiple nodes of one or more data centers. With distributed SQL, data is partitioned and distributed such that each node stores a subset of the data and these nodes communicate to ensure the consistency of the data across the cluster. Distributed SQL query engines are designed to process and execute SQL queries across these multiple nodes of a cluster, enabling the processing of very large datasets efficiently. Distributed SQL provides high availability, scalability, and fault tolerance.

In-memory distributed SQL query engines enhance query performance by utilizing in-memory data structures for processing the SQL queries. In particular, with in-memory distributed SQL query engines, the data tables of the database are stored directly in the memory, e.g., the Random Access Memory (RAM), instead of in drives or other relatively higher latency storage devices. Specialized data structures provide the indexing of the data records in the memory, which act as pointers to specific rows and columns, while the actual physical data is compressed and non-relational in format. Because the data structures required to access records of the database are in-memory, they can be accessed very quickly to thereby reduce response times.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises obtaining machine learning training data comprises first features extracted from logs and metadata associated with data accesses in response to in-memory distributed query processing. The method further comprises executing machine learning training of a machine learning computer model based on the machine learning training data, to thereby train the machine learning computer model to predict data accesses based on the first features. The machine learning training generates a trained machine learning computer model. The method further comprises executing the trained machine learning computer model on second features extracted from runtime data to generate a prediction of one or more datasets that will be accessed. In addition, the method comprises executing a movement of the one or more datasets from high latency storage devices to memory based on the prediction.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating an automated tiered storage architecture in accordance with one illustrative embodiment;

FIG. 3 is a flowchart outlining an example operation for performing machine learning based in-memory distributed query processing in accordance with one illustrative embodiment;

FIG. 4 is an example diagram of computer logic for implementing a prediction component in accordance with one illustrative embodiment;

FIG. 5 is an example diagram of computer logic for implementing a data tiering functionality in accordance with one illustrative embodiment;

FIG. 6 is an example diagram of computer logic for implementing a memory management component in accordance with one illustrative embodiment;

FIG. 7 is an example diagram of computer logic for implementing a storage management component in accordance with one illustrative embodiment;

FIG. 8 is an example diagram of computer logic for implementing a monitoring and feedback component in accordance with one illustrative embodiment; and

FIG. 9 is an example diagram of computer logic for a prediction data management integration in accordance with one illustrative embodiment.

### DETAILED DESCRIPTION

The illustrative embodiments provide a computing tool and computing tool functionality for performing automatic storage tiering for in-memory distributed query engines based on machine learning. As noted above, in-memory distributed query engines, such as in-memory distributed Structured Query Language (SQL) search engines, can improve the performance of distributed databases by providing in-memory data structures that can be accessed quickly to perform searches of the database. However, while these data structures, e.g., data tables, may be stored in-memory, the actual data itself is not present in-memory but instead is stored on external storage systems from which the data must be read. Stated differently, while the in-memory data structures allow the searching to be performed more efficiently and with low latency, once the search is performed for satisfying a given query, the data still needs to be accessed from the high latency storage devices where the data is physically present. This can lead to inefficiencies, especially with regard to frequently access data stored in these relatively slower, high latency storage devices.

The illustrative embodiments address this drawback and challenge by providing a computing tool and corresponding functionality to move data to appropriate storage tiers in a tiered storage system based on predicted future access patterns. Such predictions of future access patterns may be performed by machine learning trained computer models that operate to make determinations as to the proper locations of data in the tiered storage system. These predictions ensure that frequently queried data is pre-emptively loaded into memory to optimize query performance and resource utilization. With the mechanisms of the illustrative embodiments, an automated data management system (DMS) for in-memory distributed query processing, more simply referred to herein as a DMS, is provided that comprises a prediction component and a data management component. The prediction component comprises a machine learning computer model that analyzes historical data access patterns and predicts future accesses. Based on these predictions, the data management component moves data between tiers of storage, e.g., from persistent storage to memory and vice versa, based on the determined likelihood that data records will or will not be accessed in the near future to service in-memory distributed queries.

With regard to the prediction component, data collection tools are utilized to collect logs and metadata regarding data accesses from storage systems of a cluster. The logs and metadata that are collected by the data collection tools may be provided in a standardized format, such as CSV, JSON, Parquet, or the like, which can be easily processed and analyzed by feature engineering tools. The feature engineering tools extract features from the collected logs and metadata, such as query frequency (number of times a particular dataset was accessed), time of access (specific times or days when the data was accessed), data size (size of the data accessed), query type (type of query, e.g., SELECT, JOIN, or the like), data dependencies (relationships between datasets), and the like, for the historical data accesses or queries. The feature engineering tools may normalize or transform the extracted features as needed, e.g., one-hot encoding for categorical variables.

Based on the extracted features, a machine learning computer model is trained using machine learning training logic to make predictions of data access operations based on the historical data access patterns represented in the extracted features. For example, in some illustrative embodiments, features extracted from data logs may comprise query frequency, time of access, data size, query type, and data dependencies. The query frequency refers to the number of times a particular dataset has been accessed, with high-frequency datasets being more likely to be moved to faster memory storage for quick access. The time of access refers to specific times of day, when the data was access, e.g., if certain dataset are access more frequently during business hours, this pattern is a strong signal that those datasets should be loaded into memory during these periods. The data size refers to the size of the accessed data, with larger dataset being candidates for preemptive moving to optimize query performance when expected access is predicted. The query type refers to the nature of the query, e.g., SELECT, JOIN, etc., where complex queries, such as JOINs may require accessing multiple datasets simultaneously, increasing the likelihood of those datasets being needed to be preloaded. Data dependencies refers to the relationships between datasets, where accessing one dataset frequently correlates with accessing another dataset. Such a relationship can help anticipate which additional datasets should be moved into faster storage when one dataset is accessed.

The features extracted from the logs and metadata may be correlated with ground truth labels that specify the data that is accessed in association with the patterns of features represented in those logs and metadata. In this way, the logs and metadata specify patterns of features which lead to particular dataset accesses and thus, can be predictive of the particular dataset accesses. The extracted features and their corresponding ground truth labels may be considered training data that is used by machine learning computer algorithms to train the machine learning computer model(s), such as via a linear regression or other machine learning training algorithm, to thereby configure the machine learning computer model to make predictions of data or dataset accesses based on runtime input features. The training data may be split into a training data set and a validation data set for training the machine learning computer model and for validating the performance of the trained machine learning computer model after the training has been completed.

Once trained, the trained machine learning model uses similar input features from runtime data to generate predictions and instigate actions to optimize performance of the overall system. For example, the trained machine learning computer model may receive input features of the current time of day, access frequency from logs, type of active queries, data size, and the like. The trained machine learning computer model may then predict a probability score indicating the likelihood that a specific dataset will be accessed soon. If this score meets or exceeds a predetermined threshold, the dataset may be moved into memory proactively. Thus, the trained machine learning computer model dynamically optimizes data placement, improving system performance by minimizing latency and maximizing resource utilization.

For example, if a log shows that a certain dataset is frequently accessed every Monday morning by a reporting application, the machine learning computer model can learn this pattern. When similar runtime conditions are detected (e.g., the time is approaching Monday morning, and the reporting application is active), the machine learning computer model can predict that this dataset will likely need to be accessed soon. The machine learning computer model then initiates the movement of this dataset from high-latency storage (e.g., HDDs or SSDs) to in-memory storage, reducing the response time when the application actually makes the request.

In some illustrative embodiments, the machine learning computer model may be a time series forecasting model for predicting future access patterns given a pattern of input features. In some illustrative embodiments, the machine learning computer model may be a classification model, e.g., random forest, gradient boosting, etc., for predicting whether data will be accessed soon. In still other illustrative embodiments, a plurality of machine learning computer models may be implemented, of the same or different types, including one or more time series forecasting models, one or more classification models, or a combination of the two. Of course other types of machine learning computer models may be utilized in addition to, or in replacement of, these machine learning computer models as long as they may be used to predict future access patterns or data that will be accessed in the near future.

Based on the machine learning (ML) training, the trained ML computer model may then be used with features extracted from runtime logs and metadata describing current data access pattern within a given predetermined period of time. This runtime data may specify a small window of data access information from which to make predictions. Features may be extracted from this runtime data in a similar manner as for the training data, and provided as input to the trained ML computer model which then generates predictions of data accesses based on the inputs, e.g., predictions about which data, datasets, or data segments will be accessed in the near future. It should be appreciated that the term “data” refers to any individual unit or piece of information stored or processed by a computing system and may be as granular as a single record or field value (e.g., a customer ID or transaction amount), whereas a “dataset” is a collection of related data, typically structured as a table, file, or other logical grouping within a database. For example, a dataset may represent a table of customer transactions or an entire CSV file. A data segment is a finer granularity within a dataset and refers to a specific subset or partition of the dataset, such as a particular range of rows or specific columns, for example. As an example, if a dataset contains sales data spanning multiple years, a data segment may refer to only the rows pertaining to a specific year or month.

Based on the predictions, the trained ML computer model may then output a list of datasets predicted to be frequently accessed in the near future, along with any confidence scores and probability values for this listing of datasets. The listing of frequently accessed datasets may then be provided to the data management component for use in managing the data for optimizing performance of query processing, such as by moving relevant data, datasets, or data segments into memory. For example, if the machine learning computer model forecasts that a certain dataset (e.g., a table of user logs) is likely to be accessed, instead of loading the entire dataset into memory, the illustrative embodiments may only preemptively move relevant data segments (e.g., logs from the past month) to optimize resource usage based on predicted access patterns.

With regard to the data management component, the data management component implements a data tiering logic for moving data based on the predictions generated by the prediction component. The data management component further comprises memory management logic that implements strategies, such as Least Recently Used (LRU) and Least Frequently Used (LFU) caching, to manage memory resources and ensure efficient use of memory space. LRU refers to the replacement of data in the in-memory storage based on which data was least recently used. LFU refers to the replacement of data in the in-memory storage based on the data that is least frequently used.

The data management component further comprises storage management logic that implements tiered storage, compression and replication techniques, and the like. Whereas the memory management logic manages the memory, the storage management logic focuses on the management of the higher latency persistent storage devices, such as hard disks, solid state drives (SSDs), and the like. The storage management logic may use a tiered storage architecture where faster storage devices, e.g., SSDs, hold more frequently accessed data and relatively slower storage devices, e.g., HDDs, hold less frequently accessed data. The storage management logic may implement data compression techniques before storing data to disk in order to save storage space. The storage management logic may implement replication logic to replicate critical data across multiple storage devices in order to provide fault tolerance.

In addition, monitoring and feedback logic may be implemented for tracking performance metrics of the data storage system as a whole (both memory and persistent storage devices) and provides feedback to the prediction component for fine tuning the machine learning training of the machine learning computer model(s) and make improved predictions for future query processing. Examples of the performance metrics tracked may include latency, throughput, and in-memory hit rates. The feedback loop provides updates to the ML computer model with real-time performance data to improve future predictions.

With these components in place, the DMS operates to move data between persistent storage devices, such as hard disks, SSDs, and the like, and memory based on the ML computer model predictions. That is, the DMS predicts which data segments will likely be accessed frequently, and/or within a given future period of time, based on observed data access patterns and the machine learning training of the ML computer model. This informs the DMS which data segments to move to memory in anticipation of the need to access this data to service future queries. Thresholds may be set for memory usage and data access frequency to determine when to move the data segments back to persistent storage and free up the memory or otherwise overwrite the data segments in memory. These thresholds may be used with eviction policies to ensure that only the most important data resides in memory. The thresholds and eviction policies may further operate to implement an LRU and/or LFU strategy for keeping the most recently used data segments in memory and removing less frequently used data segments from the memory.

Thus, when processing in-memory distributed search queries, such as SQL queries, in-memory data structures, e.g., data tables, may be used to determine the data records from the database that need to be accessed to process the query. With the mechanisms of the illustrative embodiments, these data records will more likely be already present in-memory due to the predictions and movement of data performed by the DMS which determines a priori that these data records are likely to be accessed or are frequently accessed and moves this data from persistent storage to the memory. This prediction is based on machine learning training of one or more ML computer models and is based on the detection of data access patterns that are indicative of these data records being accessed in the near future. This prediction is not based on any static policies or simple heuristics, but rather on machine learning which allows for dynamic and informed decisions with regard to data placement. The memory and storage management components allow for efficient and optimized utilization of memory and persistent storage resources. The tracking and feedback mechanisms ensure that the DMS adapts to changes in data access patterns over time and maintains optimal performance of the DMS.

The mechanisms of the illustrative embodiments reduce query latency by proactively loading frequently accessed data into memory, leading to faster query execution and an improved user experience. By intelligently placing data in memory or on disk, the illustrative embodiments help reduce the amount of expensive memory resources needed, leading cost savings. The dynamic nature of the illustrative embodiments allow for easy scaling and adaptability to changing data access patterns, ensuring that the system remains performant even as data volumes grow. Moreover, the automated and intelligent nature of the illustrative embodiments reduce the need for manual intervention, freeing up information technology (IT) resources for other tasks.

The following description provides examples of embodiments of the present disclosure, and variations and substitutions may be made in other embodiments. Several examples will now be provided to further clarify various aspects of the present disclosure.

Example 1: A method comprising obtaining machine learning training data comprising first features extracted from logs and metadata associated with data accesses in response to in-memory distributed query processing. The method further comprises executing machine learning training of a machine learning computer model based on the machine learning training data, to thereby train the machine learning computer model to predict data accesses based on the first features, wherein the machine learning training generates a trained machine learning computer model. The method also comprises executing the trained machine learning computer model on second features extracted from runtime data to generate a prediction of one or more datasets that will be accessed. In addition, the method comprises executing a movement of the one or more datasets from high latency storage devices to memory based on the prediction. The above limitations advantageously enable predictive movement of data in a storage system to promote faster access to data based on machine learning predictions of which data will be accessed in the near future.

Example 2: The method of any of Examples 1 and 3-7, where the prediction comprises a listing of datasets that are predicted to be frequently accessed within a predetermined future window of time. The above limitation advantageously enables data that is predicted to be frequently access to be moved to a lower latency memory prior to the accesses occurring.

Example 3: The method of any of Examples 1-2 and 4-7, where the listing of datasets is predicted based on second features extracted from logs and metadata of data accesses occurring within a historical window of time prior to a current time. The above limitation advantageously enables the use of a historical accesses as a basis for predicting future access patterns so as to identify which data will likely be accessed frequently and enable movement of that data to promote faster accesses.

Example 4: The method of any of Examples 1-3 and 5-7, where the high latency storage devices comprise one or more of hard disk drives or solid state drives of a tiered storage system, and where the high latency storage devices store a database to which in-memory distributed queries are directed. The above limitations advantageously enable movement of data between tiers of a tiered storage system based on predictions of frequency of access.

Example 5: The method of any of Examples 1-4 and 6-7, further comprising receiving an in-memory distributed query directed to the database, determining if a required dataset that is required for processing the in-memory distributed query is in memory or not, and, in response to the required dataset being present in memory, processing the in-memory distributed query based on an accessing of the required dataset from the memory. The above limitations advantageously enable in-memory distributed query processing to be performed quickly based on datasets present in memory.

Example 6: The method of any of Examples 1-5 and 7, further comprising executing a movement of the one or more datasets from high latency storage devices to memory based on the prediction comprises implementing an eviction policy on data in the memory to provide available storage capacity for the one or more datasets. The above limitations advantageously enable the removal of data from memory to provide capacity to move data into the memory that is predicted to be accessed frequently in a future window of time.

Example 7: The method of any of Examples 1-6, where the eviction policy comprises one of a least recently used (LRU) policy or a least frequently used (LFU) policy to identify data to be evicted from the memory. The above limitations advantageously enable the eviction of data that, relative to other data in the memory, has not been used recently or which is not used as frequently as the other data so that new data may be moved into the memory for faster access. This reduces the amount of movement needed as the eviction is with the data that is least recently used or least frequently used and thus, is less likely to be used again in the near future.

Example 8: A computer program product comprising one or more computer readable storage media, and program instructions collectively stored on the one or more computer readable storage media, the program instructions comprising instructions configured to cause one or more processors to perform a method according to any one of Examples 1-7. The above limitations advantageously enable a computer program product having program instructions configured to cause one or more processors to perform and realize the advantages described with respect to Examples 1-7.

Example 9: A system comprising one or more processors and one or more computer-readable storage media collectively storing program instructions which, when executed by the one or more processors, are configured to cause the one or more processors to perform a method according to any one of Examples 1-7. The above limitations advantageously enable a system comprising one or more processors to perform and realize the advantages described with respect to Examples 1-7.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides computer tools and computer functionality for dynamically predicting datasets that should be moved to memory from persistent storage in anticipation of those datasets being accessed to service in-memory distributed query processing. The improved computing tool implements mechanism and functionality, such as an automated data management system for in-memory distributed query processing, which cannot be practically performed by human beings either outside of, or with the assistance of, a technical environment, such as a mental process or the like. The improved computing tool provides a practical application of the methodology at least in that the improved computing tool is able to pre-emptively predict dataset accesses and position the datasets to maximize efficient accessing of the datasets for servicing query processing.

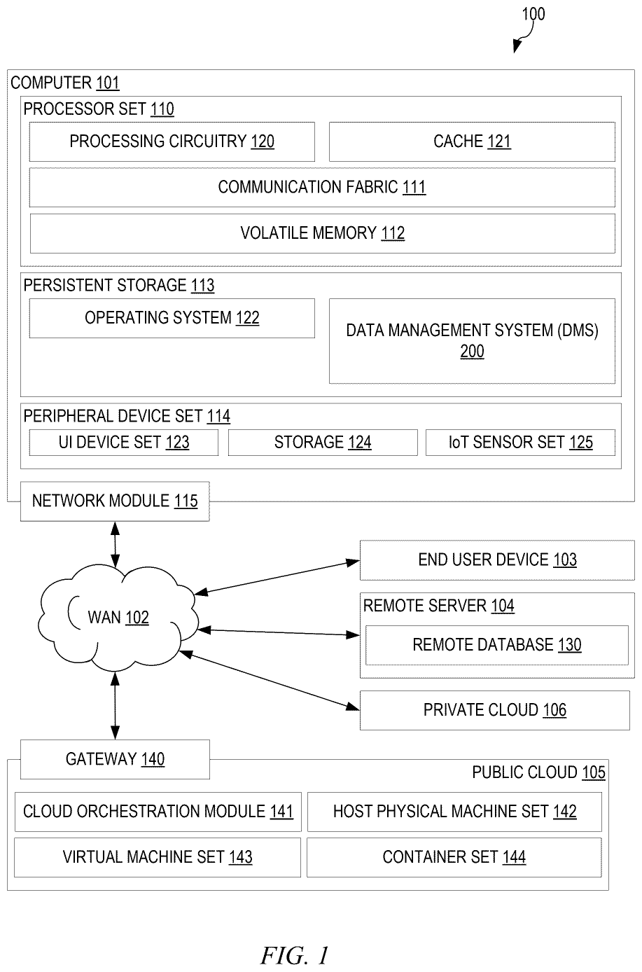

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as an automated data management system (DMS) for in-memory distributed query processing, referred to as DMS 200. In addition to DMS 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and DMS 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in DMS 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in DMS 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a DMS 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates dynamic determination of which datasets will be accessed within a given future period of time and pre-emptive movement of datasets to maximize efficient accessing of these datasets in anticipation of their need.

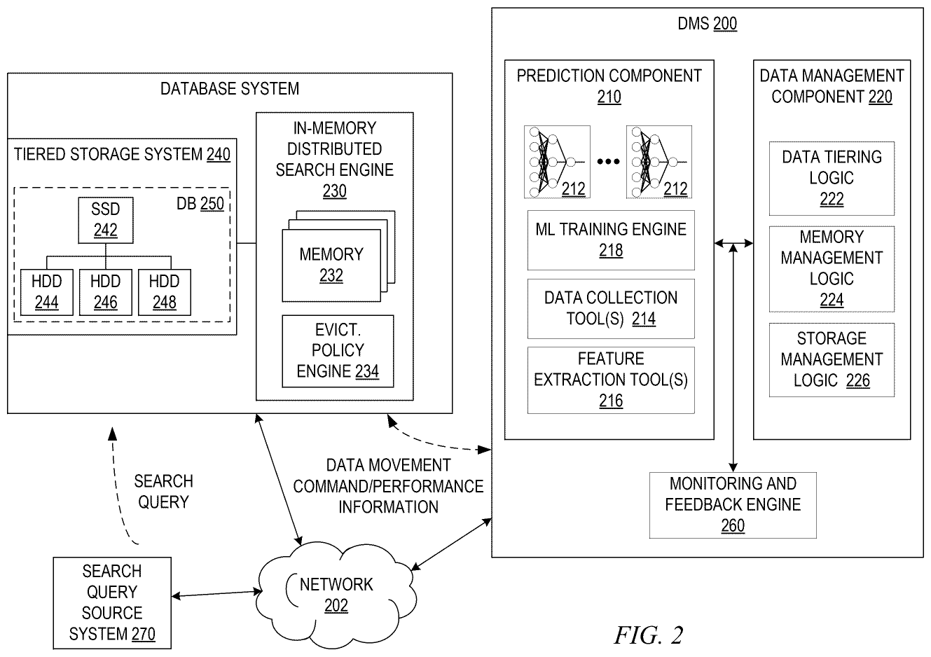

FIG. 2 is an example block diagram illustrating an automated tiered storage architecture in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that data accesses are performed for handling or servicing in-memory distributed query processing, and providing a specific solution that implements a machine learning based prediction component and a corresponding data management component that dynamically operate on observed data access patterns to predict future data access patterns and make pre-emptive dataset movements within a tiered storage system, which cannot be practically performed by human beings as a mental process and is not directed to organizing any human activity.

As shown in FIG. 2, the DMS 200 includes a prediction component 210, a data management component 220, and a monitoring and feedback engine 260. The prediction component 210 comprises one or more machine learning (ML) computer models 212, data collection tools 214, feature extraction tools 216, and machine learning training engine 218. The data management component 220 comprises data tiering logic 222, memory management logic 224, and storage management logic 226.

The computing tool and computing tool functionality of the illustrative embodiments may be implemented in conjunction with an in-memory distributed search engine 230, such as an in-memory distributed Structured Query Language (SQL) search engine via one or more data networks 202. In some illustrative embodiments, the DMS 200 may be integrated with the in-memory distributed search engine 230. The DMS 200 operates to position data for efficient and optimal accessing of datasets required to service search queries being processed by the in-memory distributed search engine 230.

The in-memory distributed search engine 230 may include one or more memory storage devices 232 which store data tables or other searchable data structures for determining which datasets need to be accessed to process a given search query, such as from search query source system 270 via one or more data networks 202. In addition, the one or more memory storage devices 232 may comprise storage capacity for storing the datasets required to process and service the search query via the in-memory distributed search engine 230. In accordance with the illustrative embodiments, the one or more memory storage devices 232 represent the fastest access data storage and thus, are the storage location to which datasets that will be accessed should be moved in anticipation of an imminent data access operation. As previously discussed, the in-memory distributed query engine 230 can improve the performance of distributed databases, such as distributed database 250, by providing in-memory data structures that can be accessed quickly to perform searches of the database 250. However, while these data structures, e.g., data tables, may be stored in-memory, i.e., in one or more memory storage devices 232, the actual data itself is not always present in-memory but instead is stored on external storage systems, such as tiered storage system 240, from which the data must be read.

Thus, the DMS 200 may operate in conjunction with, or may be integrated with, the tiered storage system 240 comprising one or more higher latency persistent storage devices 242-248, such as solid state drives (SSDs), hard disk drives (HDDs), or the like. The persistent storage devices 242-248 may be arranged in tiers based on performance capabilities, e.g., latency of data access, throughput, and the like, so that data may be moved between tiers of the tiered storage system 240 to facilitate an efficient and optimal accessing of datasets given the practical limitations of the storage devices in the tiered storage system 240.

The DMS 200 provides a computing tool and corresponding functionality to dynamically move data from the tiered storage system 240 to the one or more memories 232 based on dynamic predictions of future data access patterns given a previous data access pattern. The DMS 200 generates these predictions of future access patterns by implementing the one or more machine learning trained computer models 212 of the prediction component 210. These one or more machine learning trained computer models 212 are trained through machine learning processes to make determinations as to the proper locations of datasets in the tiered storage system 240 and memory 232 based on observations of previous data access patterns which indicate which datasets are most likely to be accessed within a given future period of time. That is, the prediction component 210 comprises one or more machine learning computer models 212 that analyze historical data access patterns, represented in features extracted from data accesses performed by the in-memory distributed search engine 230 over a predetermined historical period of time, and predicts future accesses over a predetermined future period of time. Based on these predictions, the data management component 220 moves data between tiers of storage in the storage system 240 and the memory 232, e.g., from persistent storage 242-248 to memory 232 and vice versa, based on the determined likelihood that data records will or will not be accessed in the near future to service in-memory distributed queries. These predictions ensure that frequently queried data is pre-emptively loaded into memory 232 to optimize query performance and resource utilization by the in-memory distributed search engine 230.

With regard to the prediction component 210, data collection tools 214 are utilized to collect logs and metadata regarding data accesses from storage systems, e.g., storage system 240, of a cluster, where a cluster is a cluster of nodes hosting a distributed database 250. The logs and metadata that are collected by the data collection tools 214 may be provided in a standardized format, such as CSV, JSON, Parquet, or the like, which can be easily processed and analyzed by feature engineering tools. The feature engineering tools 216 of the prediction component 210 extract features from the collected logs and metadata, such as query frequency (number of times a particular dataset was accessed), time of access (specific times or days when the data was accessed), data size (size of the data accessed), query type (type of query, e.g., SELECT, JOIN, or the like), data dependencies (relationships between datasets), and the like, for the historical data accesses or queries. The feature engineering tools 216 may normalize or transform the extracted features as needed, e.g., one-hot encoding for categorical variables.

Based on the extracted features, the machine learning training engine 218 trains the one or more machine learning computer models 212 to make predictions of data access operations based on the historical data access patterns represented in the extracted features from the logs and metadata. During training by the machine learning training engine 218, the features extracted from the logs and metadata may be correlated with ground truth labels that specify the data that is accessed in association with the patterns of features represented in those logs and metadata. In this way, the logs and metadata specify patterns of features which lead to particular dataset accesses and thus, can be predictive of the particular dataset accesses. The ground truth labels specify what datasets are accessed within a given time period in the future, relative to the features being input to the machine learning computer model 212. Thus, the machine learning computer model 212, based on the input features representing a pattern of data accesses, i.e., the training data, predicts a future dataset access pattern and this may then be compared against the ground truth labels to determine an error in the prediction. The machine learning training engine 218 then uses machine learning algorithms to modify operational parameters of the machine learning computer model 212 to minimize this error until there is a convergence of the machine learning computer model 212. This convergence may be determined to be present based on the error being minimized to a threshold level of error or less, or a predetermined number of iterations of machine learning training have been executed, for example. Once trained, validation data, which may be a portion of the features extracted from the logs and metadata but which are not used for training the machine learning computer model 212, may be used to validate performance of the trained machine learning computer model 212, e.g., accuracy of the model 212.

In some illustrative embodiments, the machine learning computer model 212 may be a time series forecasting model for predicting future access patterns given a pattern of input features. In some illustrative embodiments, the machine learning computer model 212 may be a classification model, e.g., random forest, gradient boosting, etc., for predicting whether data will be accessed soon. In still other illustrative embodiments, a plurality of machine learning computer models 212 may be implemented, of the same or different types, including one or more time series forecasting models, one or more classification models, or a combination of the two. Of course other types of machine learning computer models may be utilized in addition to, or in replacement of, these machine learning (ML) computer models as long as they may be used to predict future access patterns or data that will be accessed in the near future.

The trained ML computer model may be used with features extracted by the feature engineering tools 216 from runtime logs and metadata collected by the data collection tools 214 describing current data access pattern within a given predetermined period of time. This runtime data may specify a small window of data access information from which to make predictions. For example, the data collection tools 214 may collect logs and metadata for data accesses occurring during a time period of −T1 to 0 (where 0 represents the current time and T 1 is a size of a time window), and may then predict data accesses for a period of time in the future, i.e., 0 to T2 (where T2 is another size of a time window). It should be appreciated that T1 can be the same as T2 or may be different depending on the desired implementation. Moreover, as time progresses, this data access patterns present in the past or historical window −T1 to 0 will change in a continuous manner, which will affect the predictions of data access patterns in the future window 0 to T2. Thus, data access patterns in the past may be used to dynamically predict data access patterns in the future.

It should be appreciated that the data collection tools 214 and feature engineering tools 216 operate on the runtime logs and metadata in a similar manner as the historical logs and metadata when performing training of the ML computer models 212. That is, features may be extracted from this runtime data in a similar manner as for the training data, and provided as input to the trained ML computer model 212 which then generates predictions of data accesses based on the inputs, e.g., predictions about which data, datasets, or data segments will be accessed in the future window. The trained ML computer model 212 may then output a list of datasets predicted to be frequently accessed in the future window, along with any confidence scores and probability values for this listing of datasets, to the data management component 212.

With regard to the data management component 220, the data management component 220 implements a data tiering logic 222 for moving data based on the predictions generated by the prediction component 210. The data management component 220 further comprises memory management logic 224 that implements strategies, such as LRU and LFU caching, to manage memory resources of the memory 232 and ensure efficient use of memory space. The data management component 220 also comprises storage management logic 226 that implements tiered storage, compression and replication techniques, and the like. The storage management logic 226 may implement data compression techniques before storing data to disk in order to save storage space. The storage management logic 226 may implement replication logic to replicate critical data across multiple storage devices in order to provide fault tolerance.

In addition, monitoring and feedback logic 260 may be implemented for tracking performance metrics of the data storage system 230 as a whole (both memory and persistent storage devices) and provides feedback to the prediction component 210 for fine tuning the machine learning training of the machine learning computer model(s) 212 and make improved predictions for future query processing. Examples of the performance metrics tracked may include latency, throughput, and in-memory hit rates of the memory 232. The feedback loop provides updates to the ML computer model 212 with real-time performance data to improve future predictions. That is, the real-time performance data may be used as additional training data by the machine learning training engine 218 to fine-tune the operational parameters of the ML computer model 212. Similar to the original training, the machine learning training engine 218 may perform additional fine-tuning training of the already trained ML computer model 212 so as to adapt the trained ML computer model 212 to runtime data access patterns.

Thus, during runtime operation, the DMS 200 operates to move data between persistent storage devices 242-248 and memory 232 based on the ML computer model 212 predictions. The prediction component 210 of the DMS 200 predicts which data segments that will likely be accessed frequently, and/or within a given future window or period of time, based on observed data access patterns during a historical window of time, and the machine learning training of the ML computer model 212. This informs the DMS 200 which data segments to move to memory 232 in anticipation of the need to access this data to service future queries via the in-memory distributed query search engine 230. Thresholds may be set for memory usage and data access frequency to determine when to move the data segments back to persistent storage 242-248 and free up the memory 232 or otherwise overwrite the data segments in memory 232. These thresholds may be used with eviction policies to ensure that only the most important data resides in memory. The thresholds and eviction policies engine 234 to implement eviction policies that operate to implement an LRU and/or LFU strategy for keeping the most recently used data segments in memory 232 and removing less frequently used data segments from the memory 232.

Thus, when processing in-memory distributed search queries via the in-memory distribute search engine 230, such as SQL queries, in-memory data structures, e.g., data tables, may be used to determine the data records from the database 250 that need to be accessed to process the query. With the mechanisms of the illustrative embodiments, these data records will more likely be already present in the memory 232 due to the predictions and movement of data performed by the DMS 200 ahead of the actual need for the dataset accessing. These predictions are based on machine learning training of one or more ML computer models 212 and are based on the detection of data access patterns in a historical window of time which are indicative of the data records that will need to be accessed in the future window of time.

Again, these predictions are not based on any static policies or simple heuristics, but rather on machine learning which allows for dynamic and informed decisions with regard to data placement. The memory and storage management components 224 and 226, as well as eviction policies engine 234, allow for efficient and optimized utilization of the memory 232 and persistent storage resources 242-248. The tracking and feedback mechanisms 260 ensure that the DMS 200 adapts to changes in data access patterns over time and maintains optimal performance of the DMS 200.

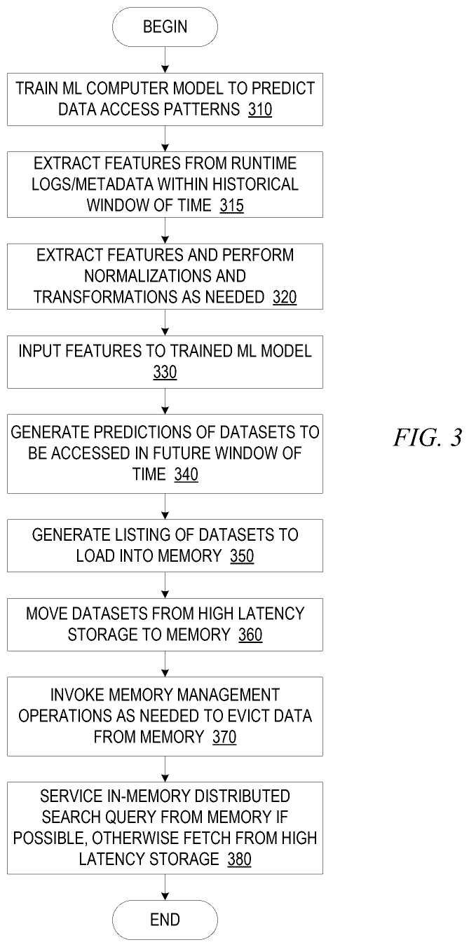

FIG. 3 is a flowchart outlining an example operation for performing machine learning based in-memory distributed query processing in accordance with one illustrative embodiment. It should be appreciated that the operations outlined in FIG. 3 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 3, and may, in some cases, make use of the results generated as a consequence of the operations set forth in FIG. 3, the operations in FIG. 3 themselves are specifically performed by the improved computing tool in an automated manner.

The operation outlined in FIG. 3 assumes a previous training of the ML computer model based on historical data accesses for distributed search queries, with this being generally represented as step 310. As noted above, this training may involve the capturing of logs and metadata by one or more data collection tools for processing search queries, extraction of features by one or more feature engineering tools, and augmentation of these features with ground truth labels to thereby generate a set of training data and a set of validation data which are then used to train the ML computer model. Once trained, the ML computer model may be deployed for processing runtime data to make predictions of data accesses that will be needed for servicing in-memory distributed search queries.

As shown in FIG. 3, assuming the previous training of step 310, the operation then collects runtime logs and metadata for data accesses occurring within a predetermined historical period of time (step 315). Features are extracted from these runtime logs and any needed normalizations or transformations of the features are performed (step 320). The resulting features are input to the trained ML computer model (step 330). The trained ML computer model processes the input features and generates a prediction of one or more datasets that are likely to be accessed within a future window of time (step 340). This prediction may include generating probabilities for each dataset as to whether the dataset will likely be accessed within the future window of time, the frequency by which that dataset is predicted to be accessed in the future window of time, confidence scores in the predictions, and the like. Based on the prediction, the probabilities, predicted frequency of data access, and confidence in the predictions, a listing of datasets to be loaded into memory is generated (step 350).

This listing is then provided to the data management component to perform operations to move the datasets in the listing to memory (step 360). The movement of the datasets may invoke memory management operations for overwriting or evicting data from memory as necessary to allow for the movement of the datasets of the listing to the memory (step 370). These memory management operations may include using a LRU or LFU replacement operation or the like. Thereafter, when an in-memory distributed search query is received by the in-memory distributed search query engine, it may access the dataset from the memory in a more rapid manner if that dataset is present in memory, rather than having to request the dataset from the higher latency persistent storage devices (step 380). The operation then terminates. While FIG. 3 shows the operation terminating, it should be appreciated that this process may be repeated continuously or periodically to keep the data in the memory up-to-date with regard to the predictions by the ML computer model such that the predicted most frequently accessed datasets are updated and maintained in the memory.

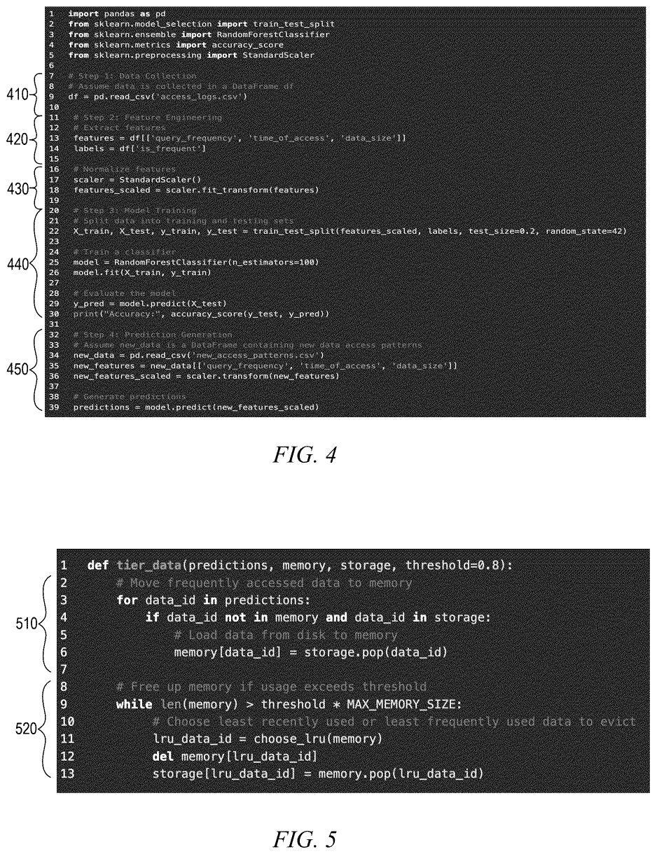

As noted above, the DMS 200 of the illustrative embodiments comprises a prediction component and a data management component. The data management component further comprises logic for data tiering in a tiered storage system, memory management, and storage management. In addition, the DMS 200 comprises a monitoring and feedback component. Each of these components may be implemented by specifically configured computing devices that are specifically configured with logic to perform their corresponding functions as described herein. FIGS. 4-8 hereafter provide examples of logic which may be used to implement the configuring of these computing devices in accordance with one or more illustrative embodiments.

FIG. 4 is an example diagram of computer logic for implementing a prediction component in accordance with one illustrative embodiment. As can be seen from FIG. 4, the prediction component includes logic 410 for data collection from a dataframe (df), logic 420 for invoking feature engineering to extract features, logic 430 to normalize or scale these features, logic 440 for invoking a model training of a machine learning computer model, and logic 450 for generating predictions based on new data. Of particular note, the computer logic of FIG. 4 uses feature engineering to capture specific characteristics of data access patterns and the training of the machine learning computer model to predict which datasets will likely be accessed. The computer logic transitions from raw data to meaningful features that feed into the machine learning computer model.

More specifically, the computer logic of FIG. 4 focuses on how the machine learning model processes input data to predict future data accesses. In block 410, a first step involves gathering logs and metadata about previous data accesses. This raw input comes from distributed database or tiered storage systems and involves a comprehensive data collection from diverse sources (e.g., access logs, metadata, and the like, to capture a wide range of indicators related to data access patterns. The logic of block 410 ensures a rich and diverse feature set for the machine learning computer model.

The feature extraction of block 420 extracts specific features from the collected logs and metadata, such as attributes including query frequency, time of access, type of query, and data size, for example. The logic of block 420 provide a comprehensive feature extraction process capturing multiple dimensions of data usage (e.g., frequency, dependencies, query type, etc.), so that the system creates a robust feature set that accurately represents user access patterns and data behavior.

The normalization and scaling of block 430 is used to adjust feature values to a standardized range prior to feeding the features into the machine learning computer model. This logic of block 430 improves the performance and convergence of the machine learning computer mode during training by ensuring that features of different magnitudes do not disproportionality influence the machine learning computer model, which leads to more balanced and effective machine learning.

In block 440, the machine learning computer model is trained using the extracted and normalized features. This process involves fitting the machine learning computer model to historical access patterns to predict future data needs accurately. The machine learning computer model dynamically learns from historical access patterns and improves over time as new data is fed into the machine learning computer model. The flexibility of using various machine learning computer model types (e.g., time series forecasting, random forest classifiers, and the like) based on the scenario adds to the robustness of the machine learning computer model operation.

In block 450, the trained machine learning computer model is used to generate predictions about future data accesses. Based on real-time input features (such as current time, ongoing queries, historical trends, and the like), the machine learning computer model outputs a list of datasets likely to be accessed soon, i.e., within a predetermined window of time. The operation of block 450 leverages real-time and historical features to anticipate future needs, enabling proactive data movement. This operation reduces latency by preemptively loading predicted datasets into memory.

FIG. 5 is an example diagram of computer logic for implementing a data tiering functionality in accordance with one illustrative embodiment. As shown in FIG. 5, the data tiering logic comprises a first portion 510 that determines if the datasets in the predictions from the prediction component are in memory or not. If the dataset is not in memory, the data is loaded from the high latency persistent storage, e.g., disk, to the memory. The data tiering logic further comprises portion 520 that determines if the length of the memory is greater than a product of a threshold and a maximum memory size. If so, then memory resources need to be freed to allow for the movement of the datasets into the memory and thus, a LRU eviction policy is implemented to evict data from the memory and make room for the datasets in the predictions. The dynamic adjustment of memory contents based on predictions in the operation of blocks 510 and 520 optimizes resource usage by pre-loading frequently accessed datasets while evicting less-used data.

In block 510, the computer logic checks whether the dataset predicted to be accessed is already present in memory. If the dataset is found in memory, the system skips the data loading step, avoiding unnecessary data movement and improving efficiency. This minimizes redundant data movement by first checking the memory for the dataset which ensures that the system only moves data when necessary, reducing I/O operations and enhancing overall system performance. However, if the dataset is not present in memory, the logic retrieves it from high-latency storage (e.g., HDD or lower-tier SSD). The data is then loaded into the faster in-memory storage to optimize upcoming query performance, which thereby proactively loads data into memory based on predicted data access patterns. Thus, the system anticipates future access needs and preemptively moves data from slower to faster storage, thereby reducing query latency.

In block 520, the computer logic checks the current memory usage against a predefined threshold. The threshold is set based on available memory capacity and system policies, ensuring that memory is not over-utilized. This computer logic provides dynamic evaluation of memory usage. The system continuously monitors memory status, making real-time decisions on data movement to prevent memory overflow and optimize resource utilization. If memory usage exceeds the set threshold, the system triggers an eviction policy to free up space, such as Least Recently Used (LRU) or Least Frequently Used (LFU), which determine which data to evict based on access patterns. The use of intelligent eviction policies, such as LRU or LFU policies, allows for prioritizing frequently accessed or recently used data in the memory while evicting less critical data, enhancing memory efficiency. Once there is sufficient space in memory (either initially or after eviction), the dataset is moved from the high-latency storage to the in-memory tier. This step finalizes the proactive data placement strategy, providing an adaptive movement of data. Thus, the system ensures that critical datasets are always available in the fastest storage tier based on predictive analysis, leading to improved query performance.

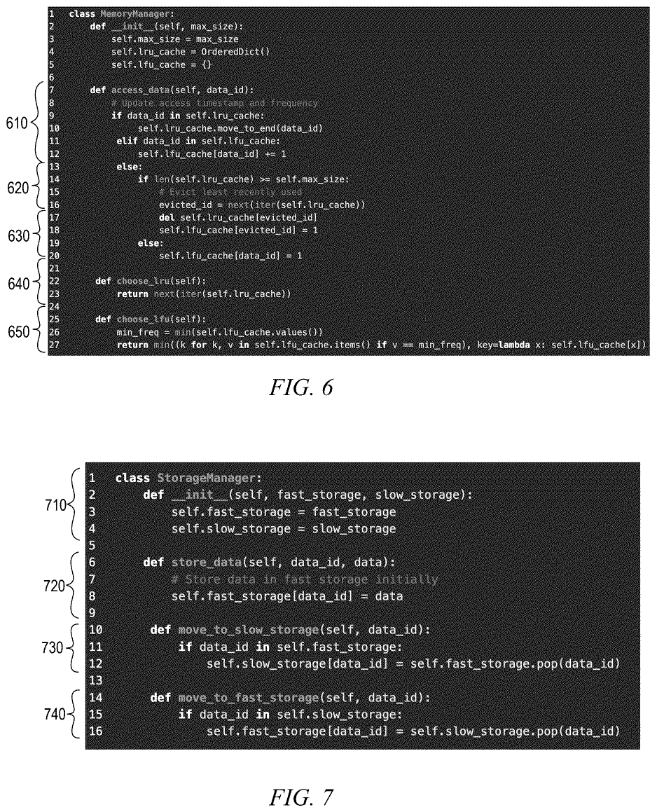

FIG. 6 is an example diagram of computer logic for implementing a memory management component in accordance with one illustrative embodiment. As shown in FIG. 6, the memory management logic comprises a first portion 610 that updates the access timestamp and frequency and evicts the least recently used data. The memory management component logic of FIG. 6 focuses on updating timestamps for access frequency and applying eviction policies, such as LRU or LFU. The memory management component logic provides a decision-making process that uses access timestamps to manage which datasets to evict, showcasing how the system maintains optimal memory usage dynamically based on real-time data access patterns.

In block 610, the memory management component logic updates metadata related to the dataset, including the access timestamp and frequency of usage. This metadata is used to determine which datasets are actively used and which ones are candidates for eviction. This operation ensures that the system has up-to-date information on data access patterns, enabling accurate decisions about which datasets should be retained or evicted from memory.

In block 620, the memory management component logic evaluates the current memory usage against a predefined capacity threshold. If memory usage exceeds this threshold, the system triggers the eviction process to free up space. The dynamic evaluation of memory usage allows the system to adapt to fluctuating workloads, preventing memory overflow and optimizing memory resources in real-time.

In block 630, the memory management component logic chooses an eviction policy, such as Least Recently Used (LRU) or Least Frequently Used (LFU), to determine which dataset should be evicted. LRU evicts the dataset that has not been accessed for the longest time. LFU evicts the dataset with the least access frequency. The flexibility of using either LRU or LFU based on the specific usage pattern allows the system to choose the most appropriate strategy based on real-time access data, enhancing the efficiency of memory usage.

In block 640, the memory management component logic, based on the selected eviction policy, identifies and removes the least valuable dataset from memory. The freed space is then made available for incoming datasets that are predicted to be accessed soon. The intelligent eviction process helps maintain optimal memory utilization. By focusing on retaining high-value data, the system minimizes latency for frequently accessed datasets and enhances overall query performance.

In block 650, after evicting the least important data, the memory management component logic loads the new dataset predicted to be frequently accessed. This ensures that the dataset is readily available for quick access, reducing potential delays in query processing. The proactive loading of predicted datasets into memory showcases the system's predictive and adaptive capabilities, improving query response times and optimizing resource allocation.

FIG. 7 is an example diagram of computer logic for implementing a storage management component in accordance with one illustrative embodiment. As shown in FIG. 7, the storage management logic comprises a first portion 710 for defining the initialization of fast and slow storage tiers. The storage management logic further comprises a second portion 720 for storing data in fast storage initially, and then operations 730 and 740 for moving data from the fast storage to the slow storage or from slow storage to the fast storage, respectively. The storage management component logic of FIG. 7 illustrates the adaptive nature of tiering in the illustrative embodiments, where data is moved between storage layers based on predicted future access, reducing latency and enhancing query performance.

In block 710, the storage management component logic initializes the structure for managing fast (e.g., SSD) and slow (e.g., HDD) storage tiers. The fast storage tier is designed to store frequently accessed data, while the slow storage tier holds less frequently accessed data. The dynamic separation of storage tiers based on latency and throughput characteristics provides a flexible framework that allows the system to adapt data placement strategies according to predicted access patterns, optimizing overall system performance.

In block 720, the storage management component logic, when new data is first introduced into the system, initially places the new data in fast storage. This ensures that new or recently accessed datasets benefit from low-latency access, improving response times for immediate queries. This provide proactive placement of new datasets into fast storage which allows for quick initial access, leveraging predictions about the likelihood of future access spikes soon after data insertion.

In block 730, the storage management component logic moves data to slow storage to free up space for more frequently accessed datasets when data in fast storage has not been accessed recently and is identified as low priority based on usage patterns. This logic enables dynamic tiering, where the system monitors access patterns and adapts data placement accordingly. This logic enables seamless transitioning between storage tiers without manual intervention, optimizing the use of high-speed storage.

In block 740, the storage management component logic, when a dataset in slow storage is predicted to be accessed frequently again (e.g., based on new user queries or updated access patterns), moves that dataset, or a data segment of that dataset, back to fast storage. This ensures that datasets, or data segments of the dataset, that are likely to be queried soon are available in low-latency storage. This promotion process is driven by machine learning predictions, enabling the system to anticipate data access needs and proactively adjust storage placement. This predictive approach helps reduce access times and improve query performance.

FIG. 8 is an example diagram of computer logic for implementing a monitoring and feedback component in accordance with one illustrative embodiment. As shown in FIG. 8, the monitoring and feedback logic comprises a first portion 810 for initializing the performance monitor and defining performance metrics of latency, throughput, and memory hit rate. The monitoring and feedback logic further comprises a second portion 820 for tracking latency, a third portion 830 for tracking throughput, and a fourth portion 840 for tracking memory hit rate. The monitoring and feedback logic gets these metrics 850 and provides feedback 860 to update the predictions based on the performance metrics. The feedback loop of the feedback component logic adjusts the predictions and tiering decisions based on real-time performance, allowing the system to adapt to changing usage patterns dynamically, optimizing performance continuously

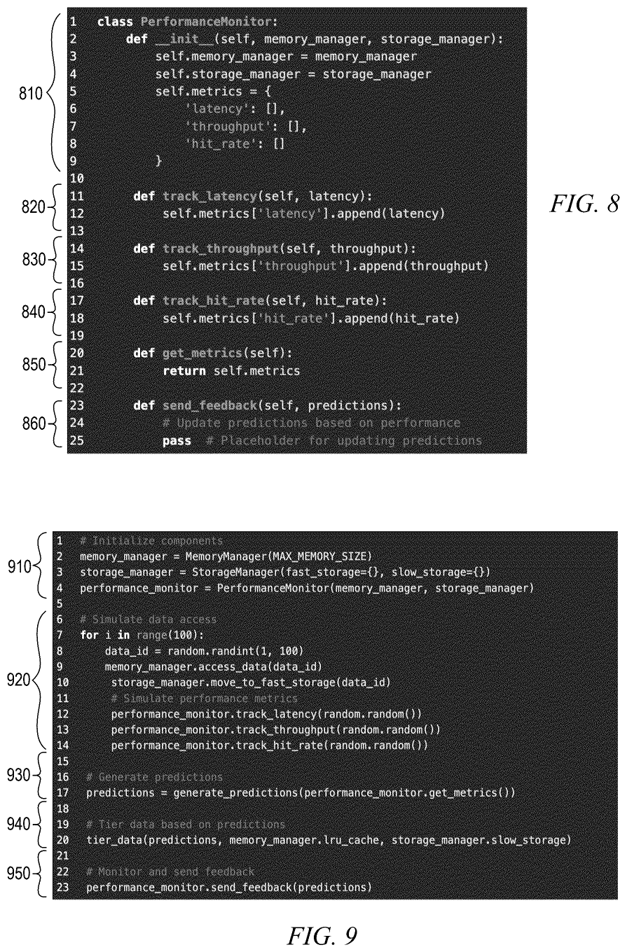

FIG. 9 is an example diagram of computer logic for a prediction data management integration in accordance with one illustrative embodiment. The logic of FIG. 9 shows the overall operation for simulating data accesses, generating predictions, tiering the data based on the predictions, and monitoring performance and sending feedback to update the predictions. This operation integrates the component logic described above with regard to FIG. 4-8. The operation of FIG. 9 provides a holistic approach of integrating prediction, tiering, and feedback with coordination between the various components to provide a dynamic system that continuously optimizes data placement in memory to reduce query latency and improved performance.

As shown in FIG. 9, the prediction data management integration example comprises a first portion 910 for initializing the components of a DMS, such as DMS 200, which includes initialization of the memory manager, storage manager, and performance monitor. A second portion 920 simulates data access including loading the data initially to fast memory storage and simulating performance metrics of latency, throughput, and hit rate. A third portion 930 generates predictions using the machine learning computer model, and a fourth portion 940 tiers the data based on the predictions. A fifth portion 950 provides performance monitoring information and sends feedback for updating the predictions.

Thus, as noted above, the illustrative embodiments provide a computing tool and computing tool functionality that is able to dynamically determine, via machine learning trained computer models, how to move data between relatively slower persistent storage devices and relatively faster memory, in anticipation of data access requirements for servicing in-memory distributed search queries. The mechanisms of the illustrative embodiments improve upon existing technology in that the mechanisms are not limited to static policies and simple heuristics but can leverage machine learning and artificial intelligence to dynamically make informed decisions about data placement. Moreover, the mechanisms of the illustrative embodiments provide automated tiering of data which reduces manual intervention and optimizes resource utilization on a continuous basis. The combination of data movement strategies and tiered storage ensures that the system uses memory and storage resources efficiently while balancing cost and performance. The monitoring and feedback mechanisms ensure that the system adapts to changes in data access patterns over time, thereby maintaining optimal performance.

With regard to in-memory distributed query processing, the mechanisms of the illustrative embodiments reduce query latency by proactively loading frequently accessed data into memory in a dynamic manner, leading to faster query execution and improved user experiences. By intelligently placing data into memory or persistent storage, the illustrative embodiments reduce the amount of expensive memory resources needed, leading to cost savings. The dynamic nature of the illustrative embodiments allows for easy scaling and adaptability to changing data access patterns, ensuring that the system remains performant even as data volumes grow. The automated and intelligent nature of the illustrative embodiments reduces the need for manual intervention, freeing up information technology resources for other tasks.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining machine learning training data comprising first features extracted from logs and metadata associated with data accesses in response to in-memory distributed query processing;
executing machine learning training of a machine learning computer model based on the machine learning training data, to thereby train the machine learning computer model to predict data accesses based on the first features, wherein the machine learning training generates a trained machine learning computer model;
executing the trained machine learning computer model on second features extracted from runtime data to generate a prediction of one or more datasets that will be accessed; and
executing a movement of the one or more datasets from high latency storage devices to memory based on the prediction.

2. The method of claim 1, wherein the prediction comprises a listing of datasets that are predicted to be frequently accessed within a predetermined future window of time.

3. The method of claim 2, wherein the listing of datasets is predicted based on second features extracted from logs and metadata of data accesses occurring within a historical window of time prior to a current time.

4. The method of claim 1, wherein the high latency storage devices comprise one or more of hard disk drives or solid state drives of a tiered storage system, and wherein the high latency storage devices store a database to which in-memory distributed queries are directed.

5. The method of claim 4, further comprising:
receiving an in-memory distributed query directed to the database;
determining if a required dataset that is required for processing the in-memory distributed query is in memory or not; and
in response to the required dataset being present in memory, processing the in-memory distributed query based on an accessing of the required dataset from the memory.

6. The method of claim 1, wherein executing a movement of the one or more datasets from high latency storage devices to memory based on the prediction comprises implementing an eviction policy on data in the memory to provide available storage capacity for the one or more datasets.

7. The method of claim 6, wherein the eviction policy comprises one of a least recently used (LRU) policy or a least frequently used (LFU) policy to identify data to be evicted from the memory.

8. A computer program product comprising:
one or more computer-readable storage media; and
program instructions stored on the one or more computer-readable storage media to perform operations comprising:
obtaining machine learning training data comprising first features extracted from logs and metadata associated with data accesses in response to in-memory distributed query processing;
executing machine learning training of a machine learning computer model based on the machine learning training data, to thereby train the machine learning computer model to predict data accesses based on the first features, wherein the machine learning training generates a trained machine learning computer model;
executing the trained machine learning computer model on second features extracted from runtime data to generate a prediction of one or more datasets that will be accessed; and
executing a movement of the one or more datasets from high latency storage devices to memory based on the prediction.

9. The computer program product of claim 8, wherein the prediction comprises a listing of datasets that are predicted to be frequently accessed within a predetermined future window of time.

10. The computer program product of claim 9, wherein the listing of datasets is predicted based on second features extracted from logs and metadata of data accesses occurring within a historical window of time prior to a current time.

11. The computer program product of claim 8, wherein the high latency storage devices comprise one or more of hard disk drives or solid state drives of a tiered storage system, and wherein the high latency storage devices store a database to which in-memory distributed queries are directed.

12. The computer program product of claim 11, further comprising:
receiving an in-memory distributed query directed to the database;
determining if a required dataset that is required for processing the in-memory distributed query is in memory or not; and
in response to the required dataset being present in memory, processing the in-memory distributed query based on an accessing of the required dataset from the memory.

13. The computer program product of claim 8, wherein executing a movement of the one or more datasets from high latency storage devices to memory based on the prediction comprises implementing an eviction policy on data in the memory to provide available storage capacity for the one or more datasets.

14. The computer program product of claim 13, wherein the eviction policy comprises one of a least recently used (LRU) policy or a least frequently used (LFU) policy to identify data to be evicted from the memory.

15. A computer system comprising:
a processor set;
one or more computer-readable storage media; and
program instructions stored on the one or more computer-readable storage media to cause the processor set to perform operations comprising:
obtaining machine learning training data comprising first features extracted from logs and metadata associated with data accesses in response to in-memory distributed query processing;
executing machine learning training of a machine learning computer model based on the machine learning training data, to thereby train the machine learning computer model to predict data accesses based on the first features, wherein the machine learning training generates a trained machine learning computer model;
executing the trained machine learning computer model on second features extracted from runtime data to generate a prediction of one or more datasets that will be accessed; and
executing a movement of the one or more datasets from high latency storage devices to memory based on the prediction.

16. The computer system of claim 15, wherein the prediction comprises a listing of datasets that are predicted to be frequently accessed within a predetermined future window of time.

17. The computer system of claim 16, wherein the listing of datasets is predicted based on second features extracted from logs and metadata of data accesses occurring within a historical window of time prior to a current time.

18. The computer system of claim 15, wherein the high latency storage devices comprise one or more of hard disk drives or solid state drives of a tiered storage system, and wherein the high latency storage devices store a database to which in-memory distributed queries are directed.

19. The computer system of claim 18, further comprising:
receiving an in-memory distributed query directed to the database;
determining if a required dataset that is required for processing the in-memory distributed query is in memory or not; and
in response to the required dataset being present in memory, processing the in-memory distributed query based on an accessing of the required dataset from the memory.

20. The computer system of claim 15, executing a movement of the one or more datasets from high latency storage devices to memory based on the prediction comprises implementing an eviction policy on data in the memory to provide available storage capacity for the one or more datasets.
